(19) United States
(12) Patent Application Publication
(10) Pub. No.: US 2010/0288092 A1
(43) Pub. Date: Nov. 18, 2010

(54) VIBRATION CUTTING DEVICE AND METHOD FOR VIBRATION CUTTING

(75) Inventors: Christoph Manger, Seligenstadt (DE); Joerg Sawatzki-Forster, Gehrden (DE)

Correspondence Address: HARNESS, DICKEY & PIERCE, P.L.C., P.O. BOX 828, BLOOMFIELD HILLS, MI, 48303, US

(73) Assignee: BRANSON ULTRASCHALL NIEDERLASSUNG DER EMERSON TECHNOLOGIES GMBH & CO., OHG, Dietzenbach (DE)

(21) Appl. No.: 12/744,101

(22) PCT Filed: Nov. 27, 2008
(86) PCT No.: PCT/EP2008/010091

§ 371 Date: May 21, 2010

(30) Foreign Application Priority Data
Nov. 29, 2007 (DE) 10 2007 057 468.3

(51) Int. Cl. B26D 1/00; B27B 13/16; B26D 1/547; B27B 13/04

(52) U.S. Cl. 83/13; 83/789; 83/651.1

(57) ABSTRACT

The present invention discloses a vibration cutting device and a method for vibration cutting. The vibration cutting device comprises at least one first oscillating heat, a controller, by means of which the first oscillating head can be selectively electrically excited in order to carry out oscillations within a frequency range below the kilohertz range, and a cutting tool disposed between a first and a second fixture, while the first fixture is connected to the first oscillating head such that mechanical oscillations of the first oscillating head can be transferred to the cutting tool.

### CROSS-REFERENCE TO RELATED APPLICATIONS

This application is a National Stage of International Application No. PCT/EP2008/010091, filed Nov. 27, 2008, which claims priority to DE 10 2007 057 468.3, filed Nov. 29, 2007, the entire disclosures of which are incorporated herein by reference.

### FIELD

The present invention relates to a vibration cutting device and a method for vibration cutting.

### BACKGROUND

This section provides background information related to the present disclosure which is not necessarily prior art.

Various cutting devices are known in the prior art, as for instance, automatic knives from the field of kitchen equipment or ultrasonic sonotrodes with a cutting tool.

Cutting by means of ultrasound is accomplished by oscillations in the kilohertz range at cutting tool amplitudes in the micrometer range. Because of the up-and-down motion of the cutting sonotrodes, it is more comparable to chopping than conventional cutting. Ultrasonic cutting finds an application for instance in the foodstuffs industry. The disadvantage with ultrasonic cutting is that the amplitudes of the cutting tool in the micrometer range render a serrated structure of the cutting tool ineffective because the tooth dimension of the cutting tool is larger than the maximum realizable amplitude of said tool. It is furthermore disadvantageous that the length of the cutting tool in ultrasonic cutting is less than 30 cm, since the cutting tool would otherwise become unstable during operation. This limited length of the cutting tool, however, disadvantageously limits the range of application of ultrasonic cutting. In addition, almost exclusively vertical and diagonal cutting is possible with ultrasound. If a horizontal cut is to be applied by means of ultrasonic cutting sonotrodes, the upper cutting member automatically lies on the cutting sonotrode, which is, however, not desirable.

The object of the present invention is, therefore, to provide a cutting device and a method for cutting that can be used in a broad range of applications and is economically usable.

### SUMMARY

This section provides a general summary of the disclosure, and is not a comprehensive disclosure of its full scope or all of its features.

The above object is achieved by a vibration cutting device in accordance with independent claim 1 and by a method for vibration cutting in accordance with independent claim 12. Advantageous embodiments and further developments of the present invention become clear from the following description, the drawings and the appended claims.

The vibration cutting device in accordance with the invention has the following features: at least one first oscillating head, a controller with which the first oscillating head can be selectively excited in order to carry out oscillations within a frequency range below the kilohertz range, and a cutting tool disposed between a first and a second fixture, while at least the first fixture is connected to the first oscillating head so that mechanical oscillations of the first oscillating head can be transferred to the cutting tool.

With the aid of the device in accordance with the invention, mechanical oscillations are transferred to a cutting tool at a frequency below the ultrasonic range. This selectively chosen frequency range opens up the possibility of applying both the oscillating motion of the cutting tool and a special geometry of the cutting tool, for instance saw teeth, in combination. The oscillating head being used is, for instance, known from the vibration welding of plastics and is remarkable for its long service life and low wear. While the cutting tool is attached to the two fixtures, the oscillations of the at least one oscillating head are introduced into only one or both fixtures. If oscillations are introduced into only one fixture, the other fixture or only the other end of the cutting tool, for instance, is mounted flexibly in order to be able to follow the unilaterally introduced oscillation.

In accordance with one embodiment of the present vibration cutting device, its oscillating head is connected by way of a spring package to the first fixture. In addition, it is preferable to use a second oscillating head that is connected to the second fixture in combination with the first oscillating head, while the first and the second oscillating head are connected electrically and/or mechanically.

The use of the spring package in combination with one or more oscillating heads facilitates the actuation and maintenance of the oscillations in the cutting tool required for cutting. Depending on the installation space available and the materials to be cut, one, two or a plurality of oscillating heads can be used in combination that transmit the cutting motion to the cutting tool. In order to achieve optimal oscillation generation of the at least two oscillating heads, said heads are actuated through a common electrical control circuit. Based on this electrical coupling of the at least two oscillating heads, said heads are actuated in such manner that the oscillating energy they generate is optimally supplemented. It is, for instance, preferable to operate the oscillating heads in the resonance range. In addition to electrical coupling, mechanical coupling of the at least two oscillating heads can be utilized in combination, or as an alternative. Mechanical coupling of this kind can be realized, for instance, through a rigid connection between the at least two oscillating heads that facilitates synchronous actuation of the least two oscillating heads.

It is preferable to operate the vibration cutting device in a frequency range from 50 to 500 Hz, preferably 50 to 60 Hz. In a further embodiment of the present vibration cutting device, the cutting tool is displaced at an amplitude of ±5 mm parallel to the longitudinal axis of the cutting tool. Moreover, cutting tools with a length in the range from 10 to 150 cm, preferably 30 to 100 cm, are used. In order to implement this, cutting tools are used that consist, for instance, of a smooth blade, a serrated blade, a wire or a cord.

In a further embodiment of the present invention, the vibration cutting tool includes a work table for a product to be cut, while the work table can be moved at least perpendicular to the longitudinal axis of the cutting tool, preferably in all three spatial directions, or the cutting tool can be moved parallel to the work table, preferably in all three spatial directions.

Using the work table specified above, a product to be cut is selectively fed to the vibration cutting device. For this purpose, the product to be cut is retained by the work table, fastened to said table, advanced by said table to the vibration cutting device and/or removed by said table from the vibration cutting device. In the simplest embodiment, the attachment and selective feed and removal of the product to be cut can be realized by a movement perpendicular to the longitudinal axis of the cutting tool. This is implemented by moving the work table itself. It is furthermore conceivable to position a conveyor belt on the side of the work table facing the cutting device. The product to be cut is located on this conveyor belt so that, by means of the conveyor belt, selective feed and removal of the product to be cut to and from the cutting tool and a controlled movement of the cutting tool through the product to be cut result. In order to work conveniently with the vibration cutting device, it is furthermore advantageous if the work table can be moved in all three spatial directions so that a product to be cut can be positioned anywhere relative to the cutting tool. Furthermore, such movability of the work table ensures that a cut through the product to be cut can be performed in any direction. It is also preferable that the work table is permanently installed, and the product to be cut is consequently held in a specified position. In order to produce a cut through the product to be cut, the cutting tool can be moved at least parallel to the upper contact surface of the work table. It is additionally advantageous if the cutting tool can be moved in all three spatial directions so that, in spite of the work table being fixed in position, any type of cut can be realized through the product to be cut.

In a further embodiment of the vibration cutting tool, it encompasses a plurality of cutting tools that can be moved simultaneously through a product to be cut. It is preferable to align the majority of cutting tools parallel and/or at right angles to each other, with reference to their respective longitudinal axis. It is furthermore preferable to dispose the majority of cutting tools parallel and/or perpendicular to their cutting direction offset to each other. The present invention similarly discloses a method for vibration cutting that has the following steps: exciting at least one oscillating head to oscillations in a frequency range below the kilohertz range, preferably between 50 and 500 Hz, transferring the oscillations to a cutting tool through a mechanical coupling between the first oscillating head and the cutting tool, and moving a work table with a product to be cut perpendicular to the longitudinal axis of the cutting tool so that the product is cut. In a further embodiment of the above method, it optionally includes the following steps: exciting at least the first and a second oscillating head that are connected mechanically and/or electrically to each other, and displacing the cutting tool at a frequency of 50 to 60 Hz and/or an amplitude of ±5 mm parallel to the longitudinal axis of the cutting tool. As a further embodiment of this method it is conceivable to move a multiplicity of cutting tools simultaneously through a product to be cut. For this purpose, the cutting tools are disposed in an arrangement parallel and/or perpendicular to their cutting direction so that they are moved through the product to be cut in accordance with this arrangement.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a schematic side view of a first embodiment of the vibration cutting device;

FIG. 2 shows a perspective view of a further embodiment of the vibration cutting device;

FIG. 3 shows a side view of the vibration cutting device from FIG. 2; and

FIG. 4 shows a further embodiment of the vibration cutting device.

Corresponding reference numerals indicate corresponding parts throughout the several views of the drawings.

### DETAILED DESCRIPTION

Example embodiments will now be described more fully with reference to the accompanying drawings.

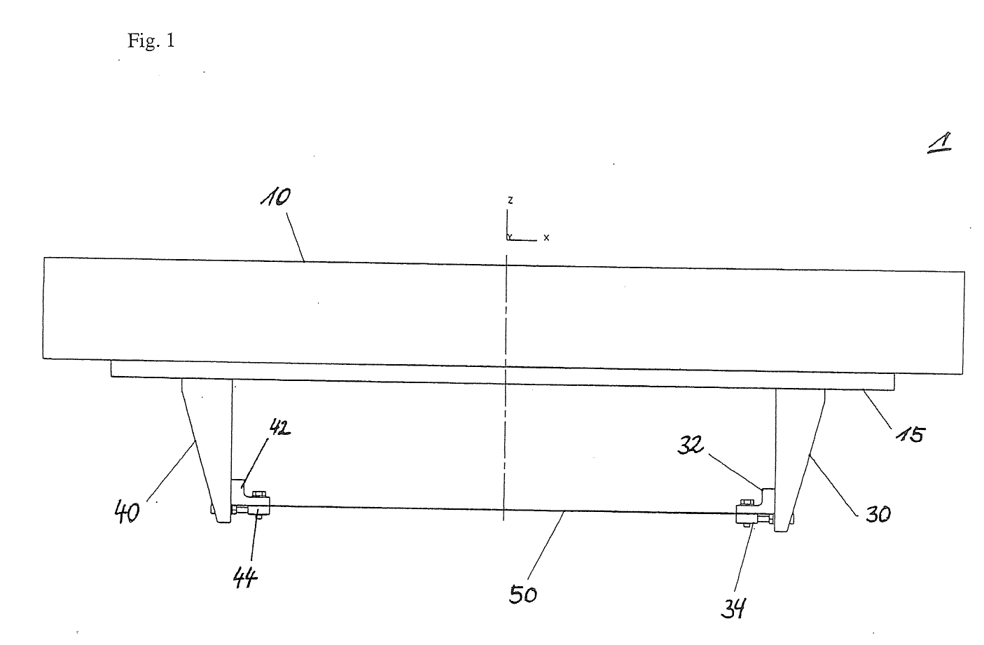

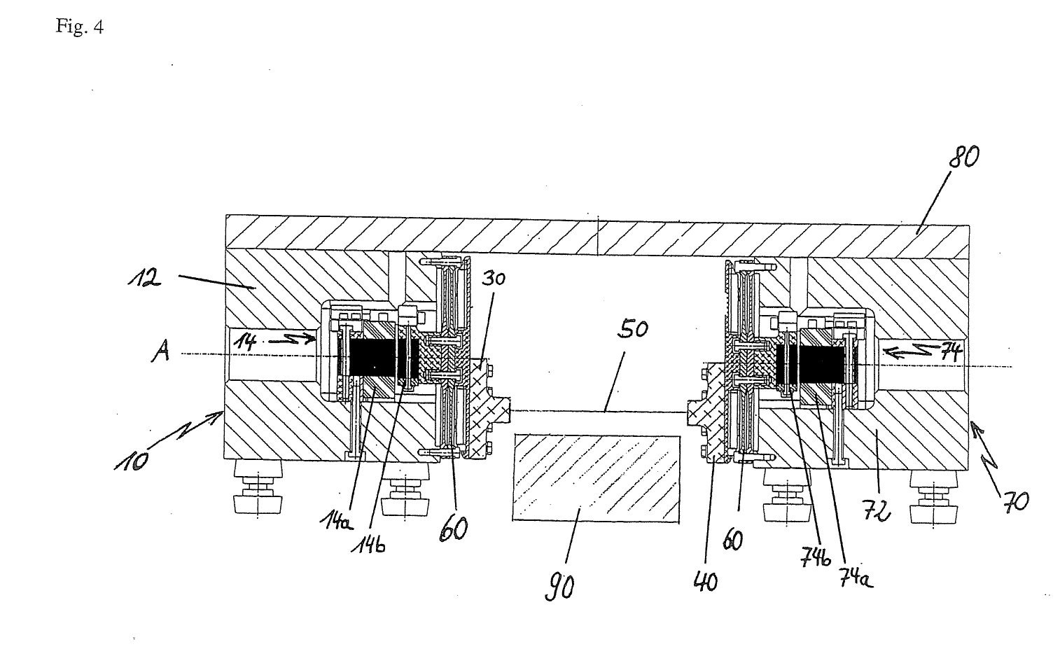

FIG. 1 shows a first embodiment of the vibration cutting device 1 in accordance with the present invention. The vibration cutting device comprises an oscillating head 10 that is connected to an oscillator plate 15. The oscillating head 10, which is explained in more detail using the example of FIG. 4, consists of an inertia body and an electromagnetic drive. The electromagnetic drive of the oscillating head is connected to controls so that mechanical oscillations in a particular frequency range can be selectively generated using the oscillating head 10. This frequency range lies between 50 and 500 Hz, that is, below the ultrasonic range with frequencies in the kilohertz range. Preferably, the oscillating head, or heads, of the vibration cutting device 1 is/are activated in such a way that a cutting tool 50 is moved at a frequency of 50 to 500 Hz, preferably 50 to 60 Hz.

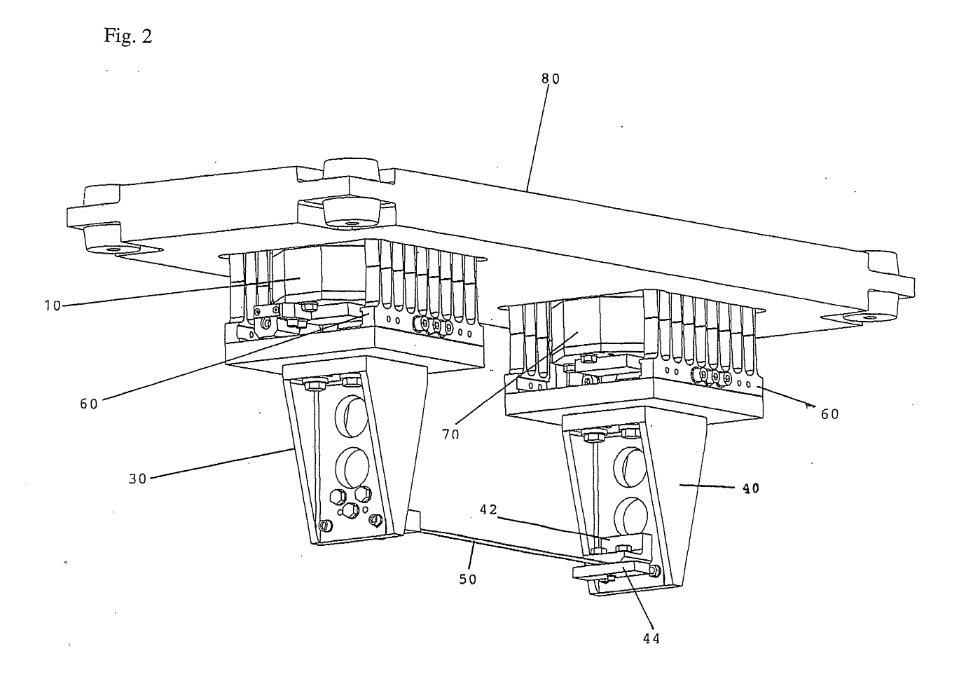

Referring to FIG. 4, the construction of the oscillating head is explained in more detail. The design of the oscillating head 10 corresponds to that of the second oscillating head 70 that is disposed opposite the first oscillating head 10. The oscillating heads 10, 70 comprise an inertia body 12, 72 and an electromagnetic drive 14, 74 consisting of a coil array 14a, 74a to which current can be applied and a soft-iron array 14b, 74b that lie on a common drive axis A. An air gap exists between the coil array 14a, 74a and the soft-iron array 14b, 74b. The soft-iron array 14b, 74b is caused to oscillate by applying current to the coil array 14a, 74a. In order to transfer the oscillations to the cutting tool 50, the soft-iron array 14b, 74b is connected by way of an optional spring package 60 to the fixture 30, 40 for the cutting tool 50 (refer to FIG. 4). In accordance with FIG. 2, the soft-iron array (not shown) is connected to the fixture 30, 40, while fixtures 30, 40 are attached resiliently by way of the spring package 60 to the bridge body 80. In accordance with the different embodiments shown, the spring package 60 consists, for instance, of disc spring-like flexible plates (refer to FIG. 4) or of a comb-like spring construction in accordance with FIG. 2. Construction and operation of the oscillating heads 10, 70 heretofore described are also described in DE 10 2006 011 974 and EP 1 772 253.

The cutting tool 50 is attached to the first fixture 30 and second fixture 40. The fixtures 30, 40 are respectively set oscillating by an oscillating head 10, 70 or by one or more common oscillating heads. It is also conceivable to set only one end of the cutting tool 50 or only one fixture 30 oscillating by coupling it to an oscillating head 10. In this case, the other end of the cutting tool 50 and/or the other fixture 40 is attached resiliently, for example by way of a spring package and/or in an antifriction bearing, to facilitate the movements of the cutting tool 50. In that case, the simplest embodiment of the vibration cutting device 1 would consist of a spring package disposed at one end of the cutting tool 50, the cutting tool 50, and an oscillating head disposed at the other end of the cutting tool 50.

In accordance with a further embodiment of the present vibration cutting device, a plurality of cutting tools 50 is set oscillating by said device. The plurality of cutting tools 50 serves to perform several cuts simultaneously in the product to be cut. It is, for instance, conceivable to cut a torte into three pieces simultaneously with the aid of the vibration cutting device 50. For this purpose, two or three cutting tools 50 are attached to the first fixture 30 and second fixture 40 in the manner described above. In addition, the several cutting tools 50 are disposed offset perpendicular to each other with reference to the direction of cutting through the product to be cut, that is, at specific intervals. This interval between the cutting tools 50 defines, for instance, the thickness of a layer to be cut out of the product to be cut. In addition, in order to prevent mutual interference between the multiple cutting tools 50 during the cutting process, they are preferably also disposed offset to each other parallel to the direction of cutting through the product to be cut. Based on this arrangement, it is ensured that the cutting tools 50 cut the product to be cut in sequence. This prevents material displaced during cutting from hampering the cutting process of a further cutting tool 50. Consequently, the multiple cutting tools 50 are disposed offset with respect to each other in height as well as in depth.

In accordance with a further embodiment of the present vibration cutting device 1, the several cutting tools, or some of the cutting tools 50, are not disposed parallel to each other. Alignments at angles to each other with respect to the longitudinal axes of the cutting tools 50 are also conceivable, in order to achieve specific cutting patterns in the product to be cut.

The first fixture 30 and second fixture 40 are preferably equipped with a clamping device 34, 44 and a tensioning device 32, 42 for the cutting tool 50 (refer to FIG. 1, 2). The clamping device 34, 44 ensures that the cutting tool 50 is positioned and guided precisely. The tensioning device 32, 42 allows the cutting tool 50 to be pre-tensioned and/or re-tensioned. The design of, and the necessity for, the clamping device 34, 44 and tensioning device 32, 42 depend on the shape and use of the cutting tool 50.

In accordance with different embodiments, the cutting tool 50 is formed of a smooth blade, a serrated blade, a blade with a scalloped profile, a wire or a cord. The cutting tool 50 is approximately 10 to 150 cm long, preferably 30 to 100 cm.

The oscillations generated by one or a plurality of oscillating heads 10, 70 are transferred by way of the fixtures 30, 40 to the cutting tool 50 in such a manner that the cutting tool 50 is displaced in the direction of its longitudinal axis. The oscillations carried out in this way by the cutting tool 50 parallel to its longitudinal axis are preset in frequency and amplitude by the controls for the oscillating heads 10, 70. The cutting tool 50 oscillates at amplitudes in the range from 5 to −5 mm. This range of amplitudes corresponds to the dimensions, for instance, of a tooth structure of a serrated blade so that the tooth structure is moved in a sawing motion in the product to be cut. Consequently, in a oscillating cutting motion of the cutting tool 50 the back-and-forth cutting motions and the geometry of the cutting tool 50, saw teeth for instance, complement each other to achieve an optimal cutting effect.

An electrical voltage is applied to the respective coil array 14a, 74a to control the oscillating heads 10, 70 individually or in combination. This electrical voltage generates an electromagnetic force in the coil array 14a, 74a that attempts to pull the soft-iron array 14b, 74b, and thus the fixture 30, 40, against the return force of the spring packages 60 towards the coil array 14a, 74a. When the electrical voltage is shut off, the return force of the spring packages 60 carries the soft-iron array 14b, 74b, and thus the fixture 30, 40, back to its initial position. During this return motion, stored energy in the spring packages 60 is converted into a movement of the soft-iron array 14b, 74b, and thus of the fixtures 30, 40, beyond their initial position. In the ideal situation of negligible losses, this happens at almost the same amplitude as in the movement towards the coil array 14a 74a. If AC voltage is applied to the coil array 14a, 74a, the soft-iron arrays 14b, 74b and the fixtures 30, 40 perform a linear, oscillating motion that is used as the drive for the vibration cutting device 1.

The oscillating head 10 operates particularly efficiently if the frequency that corresponds to the mechanical resonant frequency of the vibration cutting device 1 is used as the operating frequency for the electrical actuation of the electromagnetic drive 14, 74. The mechanical resonant frequency is essentially the result of the spring rate of the spring package 60 and the oscillating masses of the oscillating heads 10, 70. In a preferred actuation of the electromagnetic drive 14, 74, the electrical resonant frequency is equal to one half of the mechanical resonant frequency.

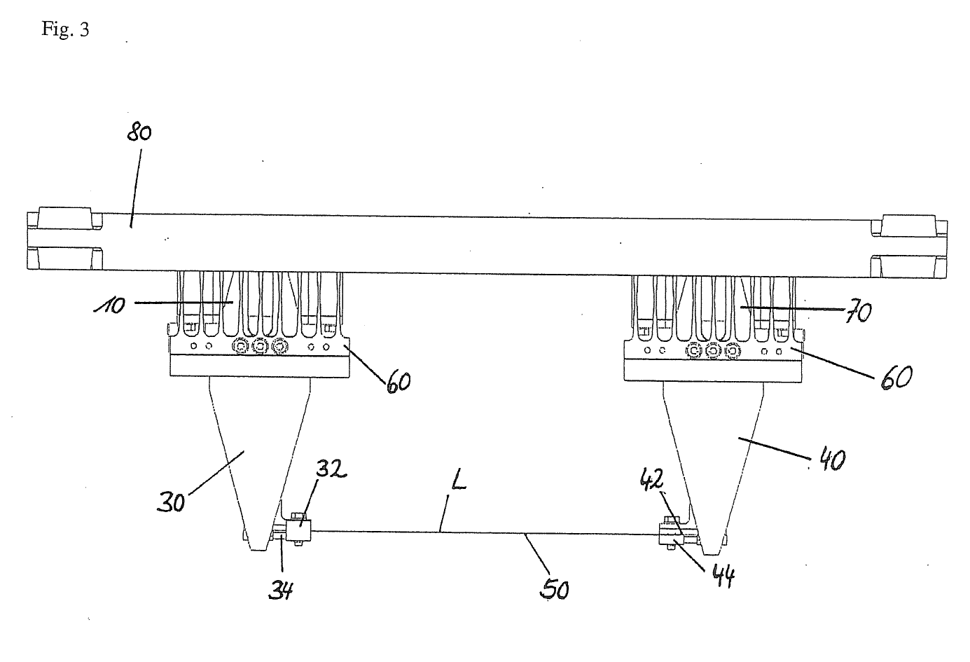

In accordance with the embodiments shown in FIGS. 2, 3, 4, the at least two oscillating heads 10, 70 are mechanically connected to each other not only through the cutting tool 50 but also through the bridge body 80. The bridge body 80 connects the inertia bodies of the oscillating heads 10, 70 so that they form a unified inertia system. In this embodiment, the coil arrays 14a, 74a of the two oscillating heads 10, 70 are electrically actuated alternately to generate a harmonic oscillation of the soft-iron arrays 14b, I74b, the fixtures 30, 40, and the cutting tool 50. The spring packages 60 of the two oscillating heads 10, 70 are thus needed only to return the oscillating head 10, 70 to its starting position, or, with the oscillating inertia bodies, to generate a mechanical resonant frequency. The deflections of the oscillating head 10, 70 from the resting position in both directions are generated by the two coil arrays 14a, 74a that are electrically actuated alternately. In this way, a stable and reliable vibration cutting device 1 is provided in which the cutting tool 50 performs a linear oscillation without superposed vertical components.

In accordance with different embodiments, it is conceivable to use or to omit the bridge body 80. If the bridge body 80 is omitted, the two oscillating heads 10, 70 are mechanically decoupled. A mechanical connection between the two oppositely disposed oscillating heads 10, 70 is provided solely by the cutting tool 50. Since a common frequency for the oscillations of the two oscillating heads 10, 70 does not result automatically in this embodiment, a corresponding electrical coupling, or common actuation, of the two oscillating heads must be provided. The frequency and the amplitude of the oscillations of the two oscillating heads 10, 70 are controlled or regulated in such a way with this control system that the frequency of the two oscillating heads 10, 70 coincides and the amplitudes are inversely phased.

The embodiments shown in the Figures represent only a selection of possible designs for a vibration cutting device 1. Consequently, in addition to the one oscillating head 10 in FIG. 1 and the two oscillating heads 10, 70 in FIGS. 2 to 4, it is also conceivable to employ a larger number of oscillating heads. They would be disposed, for instance, next to each other in groups, while the oscillating heads are then coupled together mechanically and/or electrically to each other within the groups. In particular, arrangements are possible in which both the fixtures 30, 40 and the inertial bodies of the oscillating heads 10, 70 are mechanically decoupled so that synchronization of the oscillations of the oscillating heads 10, 70 takes place exclusively through an electrical coupling and common controls.

Using the unique design features of the vibration cutting device 1 described above, vibration culling can be performed in which, initially at least, a first oscillating head is excited to oscillate in a frequency range below the kilohertz range, preferably between 50 and 500 Hz. The oscillations excited are transferred to the cutting tool 50 by the different constructions described. If a work table 90 (refer to FIG. 4) with a product to be cut disposed thereon moves perpendicular to the longitudinal axis of the cutting tool 50, the product is cut because of the oscillations of the cutting tool 50. In order to be able to match the oscillations of the cutting tool 50 optimally to the material to be cut, the mechanical and/or electrical couplings inside the vibration cutting device 1 described above are used. While, on the one hand, the work table 90 can move parallel to the cutting direction, preferably in all three spatial directions, in order to perform the desired cut, it is also preferable that the cutting tool 50 is moved while the work table 90 is fixed in place. For this purpose, the vibration cutting device 1 is disposed in such a manner that it can be moved at least in the cutting direction, preferably in all three spatial directions. In this way, any number of cuts can be made in a product to be cut. It is also conceivable to have the movement of work table 90 and/or vibration cutting device 1 computer controlled to perform a specific cut. On this basis, duration of cut, speed of cut and path of cut can be preset, can be changed while cutting, and optimally adjusted to different materials to be cut.

Regarding the movement of work table 90 and/or vibration cutting device 1, it is also conceivable to provide the movement in two spatial directions specifically to position the product to be cut or the cutting tool 50 respectively, while the motion in the third spatial direction is adjusted to the cutting process to be performed. In order to realize this, different drives in the vibration cutting device 1 and/or the work table 90 would be used for the different spatial directions since, for instance, performing a cutting motion requires a less precisely positionable but more powerful drive than a drive that is adapted specifically to positioning. It is furthermore conceivable to distribute the movement in the three spatial directions over the vibration cutting device 1 and the work table 90. While the work table 90, for example, can be adjusted only for positioning in two spatial directions, it would accordingly be sufficient if the vibration cutting device 1 were to be movable for cutting only in the third, remaining spatial direction. In this way, the degrees of freedom in movement could be divided in any manner between work table 90 and vibration cutting device 1.

In order to use the geometry of the cutting tool 50, for instance the saw-tooth structure or a scalloped edge, with the optimal cutting effect in the product to be cut, the cutting tool 50 is deflected in an amplitude range from ±1 to 10 mm, preferably ±1 to 5 mm, parallel to its longitudinal axis. In combination therewith, or by itself, it is also preferable to oscillate the cutting tool 50 at a frequency of 50 to 60 Hz.

What is claimed is:

1. Vibration cutting device that has the following features:
a) at least a first oscillating head consisting of an inertia body and an electromagnetic drive,
b) controls with which the first oscillating head can be selectively excited electrically in order to perform oscillations in a frequency range below the kilohertz range, and
c) a cutting tool disposed between a first fixture and a second fixture, while at least the first fixture is connected to the first oscillating head so that mechanical oscillations from the first oscillating head can be transferred to the cutting tool.

2. Vibration cutting device from claim 1, the oscillating head of which is connected to the first fixture by way of a spring package.

3. Vibration cutting device from claim 1 that has a second oscillating head that is connected to the second fixture, while the first oscillating head and the second oscillating head are coupled electrically and/or mechanically.

4. Vibration cutting device from claim 1 that can be operated in a frequency range from 50 to 500 Hz, preferably 50 to 60 Hz.

5. Vibration cutting device from claim 1 with which the cutting tool can be deflected at an amplitude of ±5 mm parallel to the longitudinal axis of the cutting tool.

6. Vibration cutting device from claim 1, the cutting tool of which has a length in the range from 10 to 150 cm, preferably 30 to 100 cm.

7. Vibration cutting device from claim 1, the cutting tool of which consists of a smooth blade, a serrated blade, a wire or a cord.

8. Vibration cutting device from claim 1 that further has a work table for a product to be cut, while the work table can be moved at least perpendicular to the longitudinal axis of the cutting tool, preferably in all three directions, or the cutting tool can be moved parallel to the work table, preferably in all three spatial directions.

9. Vibration cutting device from claim 1 that has a plurality of cutting tools that can be moved simultaneously through a product to be cut.

10. Vibration cutting device from claim 9, whose plurality of cutting tools are aligned parallel or at angle to each other relative to their respective longitudinal axis.

11. Vibration cutting device from claim 9 whose plurality of cutting tools is disposed offset to each other parallel and/or perpendicular to their cutting direction.

12. Method for vibration cutting that has the following steps:
a) Exciting at least a first oscillating head consisting of an inertia body and an electromagnetic drive to oscillate in a frequency range below the kilohertz range, preferably between 50 and 500 Hz, by applying current to the electromagnetic drive,
b) Transferring the oscillations to a cutting tool through a mechanical coupling between the first oscillating head and the cutting tool, and
c) Moving a work table with a product to be cut perpendicular to the longitudinal axis of the cutting tool so that the product is cut.

13. Method from claim 12 that has the additional step:
Exciting at least the first oscillating head and a second oscillating head that are coupled mechanically and/or electrically to each other.

14. Method from claim 13 that has the additional step:
Deflecting the cutting tool at a frequency of 50 to 60 Hz and/or an amplitude of ±1 to 10 mm, preferably ±1 to 5 mm, parallel to the longitudinal axis of the cutting tool.

15. Method from claim 14 that has the additional step:
Moving a plurality of cutting tools simultaneously through a product to be cut.

16. Method from claim 15 that has the additional step:
Moving the plurality of cutting tools in an arrangement parallel and/or perpendicular to their cutting direction offset to each other through the product to be cut.
